(19) United States
(12) Patent Application Publication
(10) Pub. No.: US 2022/0185514 A1
(43) Pub. Date: Jun. 16, 2022

(54) Methods and Means for Calculating and Presenting Quantitative and Qualitative Physical and Financial Metrics Associated with Stretch Films

(71) Applicant: Paragon Films, Inc., Broken Arrow, OK (US)

(72) Inventors: Chris Rapp, Broken Arrow, OK (US); Carlos Oliveira, Broken Arrow, OK (US); Paul Johnson, Broken Arrow, OK (US); Darla Phillips, Broken Arrow, OK (US); Jeff Carpenter, Broken Arrow, OK (US); Tom Roudebush, Broken Arrow, OK (US); Keith Lay, Broken Arrow, OK (US); Kenneth Mullican, Broken Arrow, OK (US)

(73) Assignee: Paragon Films, Inc., Broken Arrow, OK (US)

(21) Appl. No.: 17/412,553

(22) Filed: Aug. 26, 2021

Related U.S. Application Data
(63) Continuation of application No. 16/892,546, filed on Jun. 4, 2020, now abandoned.
Application No. 16/892,546 is a continuation of application No. 16/656,005, filed on Oct. 17, 2019, now abandoned.
(60) Provisional application No. 62/746,893, filed on Oct. 17, 2018.

(51) Int. Cl. B65B 9/13; G06Q 10/08

(52) U.S. Cl. CPC B65B 9/135; G06Q 10/087

(57) ABSTRACT

Methods and means for evaluating and summarizing physical quality metrics associated with stretch films and other plastics are provided. According to one aspect of the invention, a processor- or computer-enabled business method such as a software program or mobile application capable of calculating and comparing stretch film data and conveying easily understood summaries of film characteristics and cost impacts associated therewith is provided. According to a second aspect, the system and method provides a vast plurality of film performance metrics, costs factor, environmental impacts, and so, calculated and presented in a dashboard-type user interface.

### FIELD

The present invention relates generally to electronically delivered methods and means for evaluating and summarizing various physical quality metrics associated with stretch films, and in a particular though non-limiting embodiment to a software program or mobile application capable of calculating and comparing stretch film data and conveying easily understood summaries of film characteristics and cost impacts associated therewith.

### BACKGROUND

In the unitizing arena, stretch films are widely used to secure loads. Stretch films are utilized in a variety of bundling and packaging applications for securing bulky loads, such as boxes, merchandise, produce, equipment, parts, and other similar items onto pallets.

The ability of a stretch film to secure a load to a pallet and prevent the load from shifting, deforming, and/or falling apart is dependent on several variables, including the gauge (i.e., thickness) of the film, the amount the film is stretched or oriented prior to being wrapped around the load, the amount of force applied to the film as it is being wrapped around the load, the number of layers of film being applied to the load, and the inherent properties of the film. Load retention or load holding force is one of the most significant and important properties of a stretch film.

Stretch film end users securing pallets can realize cost savings by purchasing high quality film with excellent load holding force at reduced gauges, thereby reducing the amount of weight around a pallet. Because stretch film is priced per pound, a reduction in the number of pounds used results in cost savings. Tests such as a “cut and weigh” (in which the amount of film used to wrap a load is weighed), load containment, and on-pallet stretch have heretofore been conducted informally on site by either an end user or a stretch film distributor, but such efforts necessarily require in accurate and unreliable manual calculation of cost savings and key film performance metrics.

There is, therefore, a longstanding but currently unmet need for a mobile interactive means to accurately and reliably compare film properties and cost metrics on site, so that stretch film effectiveness and cost savings can be reliably calculated and presented to stretch film customers.

### SUMMARY

In one example embodiment, a computer or processor implemented method and means for accurately and reliably summarizing and presenting various physical qualities and financial metrics associated with various stretch films on site provides an easy to read dashboard that selectively and variably highlights key film properties. Among other metrics, the solution determines a cost per pallet wrapped comparison between and amongst various film types. In practice, results of known and future devised stretch film equipment (such as equipment type, speed, and other settings) are entered into the solution and used to calculate results, the culmination of which is presented in an easy to understand dashboard format that can, in various embodiments be pre-defined by a software program or customized for amongst a plurality of tools by an operator.

In a presently preferred though non-limiting embodiment, the solution permits a trained user to record various stretch-film related data, and then automatically generate expected performance and cost comparisons for each type of stretch film considered. In a further embodiment, the data is optimally used to demonstrate environmental benefits with respect to a reduced use of resources such as plastic, paper and energy. In addition, solution uniquely compiles data for each test conducted and is entered into an associated database or lookup table, etc. In a further embodiment, solution allows the owner or operator of the system to review and sort various test results as desired. The solution also generates a visual representation of the results, and sends such information via email, text, etc., to a designated party or other recipient.

In one detailed though non-limiting embodiment described in the attached invention disclosure support document, the entirety of which is hereby incorporated by reference, a vast plurality of film performance metrics, costs factor, environmental impacts, and so on are calculated and presented in an example dashboard-type user interface.

Ordinarily skilled artisans will readily appreciate, however, that the present invention admits to a limitless number of such factors and methods and means of calculation, organization and presentation within the scope of the instant disclosure.

The foregoing specification is provided only for illustrative purposes, and is not intended to describe all possible aspects of the present invention. While the invention has herein been shown and described in detail with respect to several exemplary embodiments, those of ordinary skill in the art will appreciate that minor changes to the description, and various other modifications, omissions and additions may also be made without departing from the spirit or scope thereof.

1. A mobile application for calculating and comparing stretch film data and conveying easily understood summaries of film characteristics and cost impacts associated therewith.
